(19) United States
(12) Patent Application Publication
(10) Pub. No.: US 2007/0100514 A1
(43) Pub. Date: May 3, 2007

(54) Remote control of conveyance and appliance functions

(76) Inventor: Tai Sung Park, San Carlos, CA (US)

Correspondence Address: CARR & FERRELL LLP, 2200 GENG ROAD, PALO ALTO, CA, 94303, US

(21) Appl. No.: 11/266,125

(22) Filed: Nov. 2, 2005

(51) Int. Cl. G06F 17/00

(52) U.S. Cl. 701/2; 701/1

(57) ABSTRACT

The present invention provides a mobile device configured with a display, keypad or other entry device, authentication transponder and wireless communication system. Through the use of the wireless communication system, a mobile device may communicate with a conveyance using wireless signals. The keypad or other entry device on the mobile device provides for the generation of conveyance control instructions such as automobile ignition, climate control, navigation settings and audio settings. An antenna at the conveyance receives the control instructions in the form of a conveyance control signal and executes an associated conveyance control command through onboard computers and power supplies whereby the engine may be started, the temperature changed, destination provided for navigation or stereo settings changed. This exchange of instructions may take place remotely from the interior of the conveyance. The display at the mobile device displays current conveyance conditions such as temperature, destination and audio settings.

### BACKGROUND OF THE INVENTION

1. Field of the Invention

The present invention pertains to keyless entry systems and mobile devices. More specifically, the present invention pertains to remotely accessing a conveyance such as an automobile and certain conveyance functions utilizing a mobile device.

2. Description of Related Art

Mobile devices, such as cellular phones, Personal Digital Assistants (PDAs) and portable music devices are essential and useful tools for the modern day lifestyle. The cost and size of mobile devices allow almost any person to have a mobile device on hand anywhere and at anytime.

Almost as ubiquitous—although certainly more expensive—is the automobile. The U.S. Department of Transportation estimates that as of February 2005, nearly 62 million vehicles were registered in the United States, approximately 42 million of which are personal automobiles. In fact, in 2004, almost 16 million new cars were sold in the United States alone.

Driving a conveyance such as an automobile or truck traditionally requires the presence of an associated key. An individual cannot enter their automobile without a key nor can they start the engine of their automobile without the aforementioned key. Conveyances such as motorcycles and scooters, while not necessarily having a door with a lock, do have similar limitations with regard to, for example, starting the engine of the conveyance.

Possessing both a mobile device and an automobile key is, for most individuals, natural and usually necessary. Many individuals do not leave their home without a mobile device (e.g., a cellular phone) and their keys for accessing and starting their automobile. Carrying such items can, however, pose certain inconveniences.

For example, despite the continued decrease in the size of mobile devices, these devices still tend to be bulky and uncomfortable when placed in a person's pants' pocket or some other article of clothing (e.g., a jacket pocket). This is especially true as mobile devices continually gravitate toward ‘smart phones.’ Smart phones represent that class of devices wherein mobile telephony is combined with other functionalities such as calendaring and contact lists. For those devices having data network capabilities, e-mail and Internet access are also provided. The increased functionality of mobile devices has led, in instances like the smart phone, to a slight increase in size due to display and keyboard requirements.

Mobile devices are also easily scratched, especially in the case of smart phones with enlarged liquid crystal displays. Scratching of a mobile device is often caused by being placed in a pants' pocket, purse or other carrying bag with some other article, for example, automobile keys.

Mobile devices and automobile keys (or any other type of key for that matter) are often easily misplaced. This is often the case when a user, because of the cramped space in their pockets, removes their mobile phone and/or keys from their pockets. Such removal is common at, for example, a restaurant as to increase the user's comfort level while eating. As a result, many users have left their keys and/or phone on a restaurant table at the conclusion of their meal having forgotten to place them back in their pockets.

Notwithstanding the inconvenience of having to continually transport both a mobile device and a set of keys, the possibility of damaging a mobile device with one's keys or the possibility of misplacing one's keys and/or mobile device as previously noted, immediate access to mobile devices and automobile keys remains a necessity in today's ‘on-the-go’ society.

As a related matter, despite the many high-tech and/or automated comforts offered by a standard automobile in the market place today (e.g., exact temperature control of air conditioning/heating, high-end stereo systems, automatic sun/moon roofs and convertible tops, GPS-mapping and so forth), operating and/or taking advantage of these various comforts requires direct intervention of the automobile owner or driver.

For example, on a cold day a driver has to get into their vehicle in order to start and warm-up the engine in order to eventually set the heating system to a suitable temperature. Despite the fact that the automobile may offer a variety of vents providing for carefully placed streams of air heated to an exact temperature, warming up the car proves to be a hassle as the driver must wait several minutes in the freezing temperature of their yet-to-be-heated vehicle until the car warms up the motor and the interior of the vehicle itself. A similar problem exists on a very hot day with regard to cooling off the interior of an automobile.

With regard to a stereo system, the driver of the car must be inside the vehicle to tune their stereo or to change CDs to eventually enjoy a particular station or track on a CD. Similar issues exist with regard to satellite radio in that actual presence is required in order to have the radio tuned to a particular favorite channel upon entry into the automobile. This tuning of the stereo or changing of CDs can be time consuming if the driver happens to be in a hurry and can be a further inconvenience if a matter of extreme weather elements is involved (e.g., rain, snow, heat or cold).

There is need in the art to minimize the various apparatus a person carries with them in their daily lives (e.g., car keys and a mobile device such as a cell phone, digital music player, PDA, etc.). There is a further need in the art to allow for enjoyment of the comforts offered by certain automobiles without having to be immediately present to activate or control those comforts.

### SUMMARY OF THE INVENTION

The present invention provides for remotely controlling environment conditions within a conveyance before entering into the closed environment of the conveyance.

The present invention also provides for remotely activating a conveyance's engine prior to entering the conveyance.

The present invention further provides for remotely controlling the audio system of a conveyance prior to entering the conveyance.

The present invention provides for remotely controlling navigational components of a conveyance prior to entering the conveyance.

The present invention provides for monitoring the status of various components or conditions of a conveyance from a remote location.

The present invention provides an advantageous device combining both mobile phone and automobile control functionality.

The present invention provides for the remote control of personal space functions through a mobile device.

### BRIEF DESCRIPTION OF THE FIGURES

FIG. 1A is a front view of an exemplary mobile device as may be utilized in an embodiment of the present invention.

FIG. 1B is a top, perspective view of the exemplary mobile device of FIG. 1A as may be used in an embodiment of the present invention.

FIG. 2 illustrates an exemplary peripheral device as may be utilized in secure digital input/output compatible mobile device in an embodiment of the present invention.

FIG. 3 illustrates an exemplary embodiment of a communication and control system as utilized in an embodiment of the present invention.

FIG. 4 illustrates an exemplary power system as governed by a body controller in an embodiment of the present invention.

FIGS. 5A-5C illustrate various exemplary views of a user interface as may be generated by a conveyance control module in a mobile device.

FIG. 6 illustrates an exemplary method for remotely controlling conveyance functions utilizing a mobile device configured with a conveyance control module.

### DETAILED DESCRIPTION OF AN EXEMPLARY EMBODIMENT

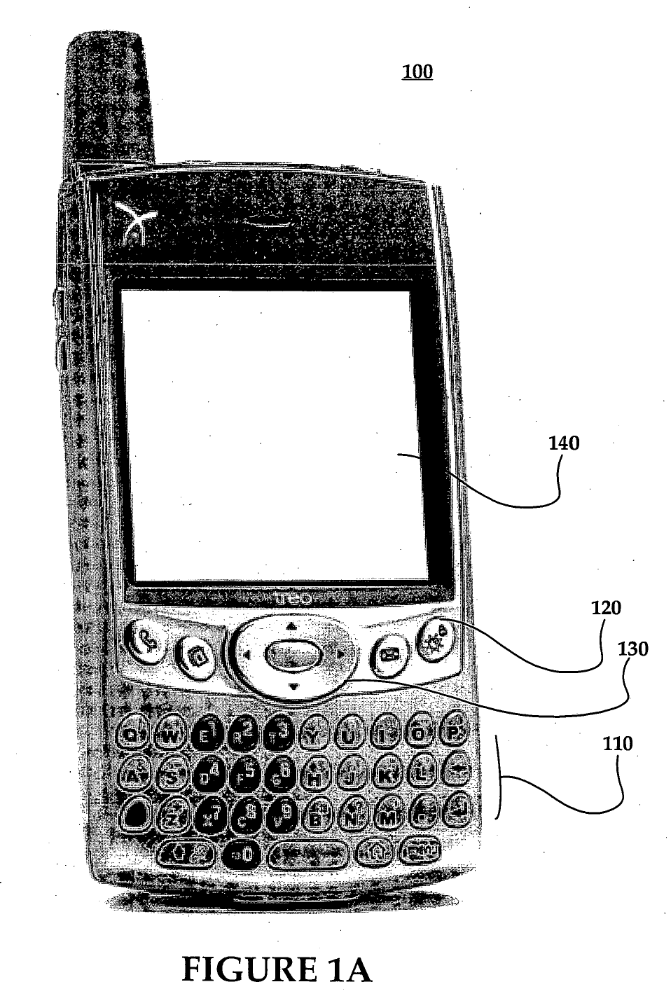

FIG. 1A illustrates a front view of an exemplary mobile device 100. Mobile device 100 may be a cellular phone, a Personal Digital Assistant (PDA) or a more complex device such as a SmartPhone like the Treo600 (as shown).

A Treo600 or other mobile device 100 may be configured to operate on the Global System for Mobile Communication (GSM) network. GSM typically operates on the 900 MHz and 1800 MHz frequencies in Europe, Asia and Australia and the 1800 MHz frequency in North and Latin America.

Mobile device 100 may also be configured for the General Packet Radio Service (GPRS), a radio technology for GSM networks that utilizes packet-switching protocols and offers flexible data transmission rates of, generally, 20 to 30 Kbps although transmissions of up to 171.2 Kbps are possible, in addition to continuous connection to the network.

Mobile device 100 may further be configured to comply with the Enhanced Data rate for GSM Evolution (EDGE) specification wherein both packet capability—Enhanced General Packet Radio Server (EGPRS)—and circuit switched capability—Enhanced Circuit Switched Data (ECSD)—are offered. The EDGE specification is incorporated herein by reference.

It is envisioned that as mobile data networks continue to evolve that mobile device 100 will be further configured to operate within those different network communication specifications (e.g., Wideband Code Division Multiple Access (WCDMA)).

Mobile device 100 comprises at least one means for generating instructions to the mobile device 100. For example, mobile device 100, in most embodiments, will comprise a keypad 110 of numbers 0-9 in addition to an asterisk (*) and pound (#) key. Some mobile devices, like the Treo600 (as shown), will comprise additional keys that in some instances cover the entire alphabet whereby QWERTY keyboard-like functionality is offered. Other keys may be provided such as a ‘menu’ key or a ‘home’ key subject to the particular design of the mobile device. These keys provide the means to generate instructions to the mobile device 100 such as a phone number to be dialed or a text or e-mail message to be delivered in the case of Internet functionality.

Keys may also be assigned particular functionality relative the device. More specifically, ‘hard’ keys 120 may be present in the mobile device 100 wherein a specific functionality is assigned to a specific key. For example, a ‘phone’ key may be present that, when pressed, results in the invocation of telephone functionality. Similarly, an ‘e-mail’ key may be present wherein an e-mail application is activated.

Mobile device 100 may further comprise a five-way navigation control 130. Five-way navigation control 130 is, in most embodiments, an oval-shaped ring offering up-down-left-right control of a cursor or other indicator on a display 140. In the center of the oval-shaped ring is a push button for indicating, for example, acceptance or approval of a task or currently highlighted entry in the display 140. Using the five-way navigation control 130, a user may navigate among and select various entries in a directory or other interface as shown on display 140.

Mobile device 100 comprises display 140 that may be configured for touch-sensitive operations. For example, a user may utilize a stylus to select or enter information as displayed on display 140. Display 140 may also be configured to recognize actual handwriting through various handwriting recognition programs. For example, PALM OS devices are typically configured with Graffiti handwriting recognition software whereby users may generate text, numerical or other character information through the use of the Graffiti handwriting language. Through touch-sensitive or handwriting recognition functionality, the display 140 may be used to provide mobile device 100 with certain instructions and/or information.

Display 140 may also be configured for ‘soft’ key functionality. A ‘soft’ key (not shown) is a graphical element portrayed on the display 140 that performs whatever function is assigned to that key, usually as listed on the display 140. A ‘soft’ key may, for example, be assigned ‘send and receive’ functionality in the case of an e-mail application or ‘speed dial’ entries in the case of phone functionality. In many instances, ‘soft’ key functionality may be easily altered by a user of the mobile device 100. That is, the user may create new ‘soft’ keys or assign new functions to pre-existing ‘soft’ keys. Such reassignment of functionality is also possible in the case of ‘hard’ keys although some devices may prevent reallocation of functionality due to particular hardware design limitations.

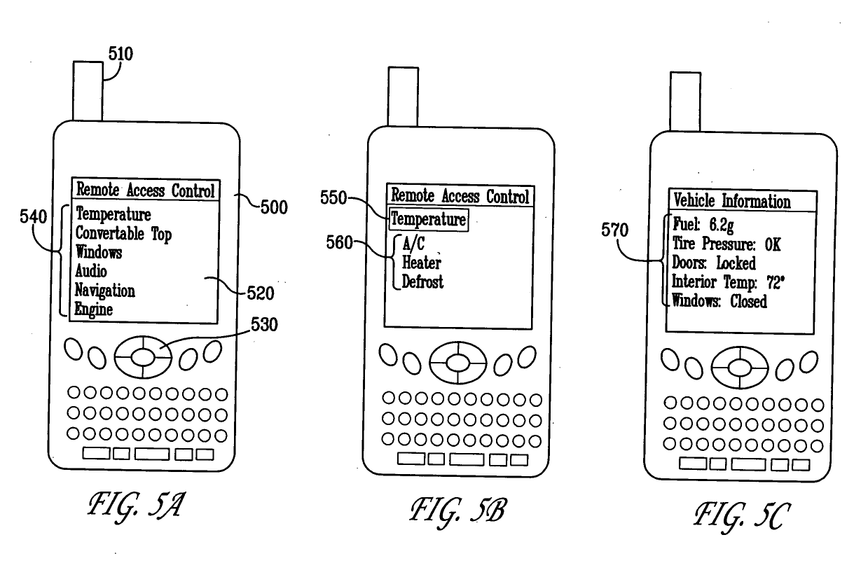

Mobile device 100 is further configured with a conveyance control module (not shown). A conveyance control module is software residing on the mobile device 100 that generates a conveyance control menu for rendering on the display 140 of the mobile device 100. The conveyance control menu generated by the conveyance control module is discussed in further detail in FIGS. 5A-5C.

The conveyance control module may be installed on the mobile device 100 at the time of manufacture and commercial delivery by an Original Equipment Manufacturer (OEM) or may be installed as part of an operation initiated by the user of the mobile device 100. For example, a user may download and install the conveyance control software module in a manner similar to a user downloading and installing a ring tone via the Short Message Service (SMS). The conveyance control module may also be installed as the result of downloading via a data connection (e.g., Internet). The conveyance control module may be further installed via a synchronization operation whereby the mobile device 100 is, for example, coupled to a computing device (e.g., a desktop computer) wherein information downloaded or resident on the computing device is subsequently transferred to the mobile device 100 as a part of the synchronization operation.

For example, a user may synchronize calendar and contact information updated on Microsoft Outlook on the computing device and also transfer new software modules downloaded at the computing device for installation on the mobile device 100 (e.g., games and other applications). This is common when a software module or other application package is of a larger size and may prove too difficult to download over sometimes limited wireless connections. In these instances, downloading to a computing device via, for example, a DSL connection and then subsequently transferring the software package over a USB connection during synchronization may prove more efficient.

The conveyance control module is also configured to accept control instructions generated by a user of the mobile device 100. For example, a user may provide certain conveyance control instructions through entry of commands or information on keypad 110, through five-way navigation control 130 or via display 140 in conjunction with certain touch-sensitive functionalities. Any other means of providing information to the mobile device 100 may also provide conveyance control instructions.

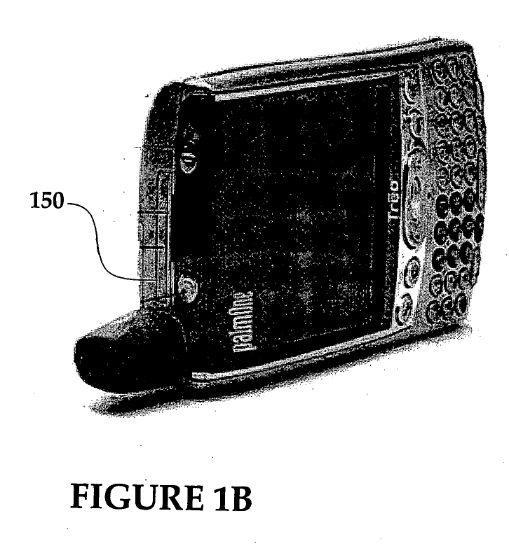

The conveyance control instructions correspond to conveyance control options displayed in the conveyance control menu. The conveyance control module, either alone or in conjunction with other hardware and software residing on the mobile device 100, translates certain key presses, navigation indications and/or screen touches (i.e., conveyance control instructions) into commands recognizable by the mobile device 100 so that they may be communicated to a peripheral device (FIG. 2) as a perpheral control instruction.

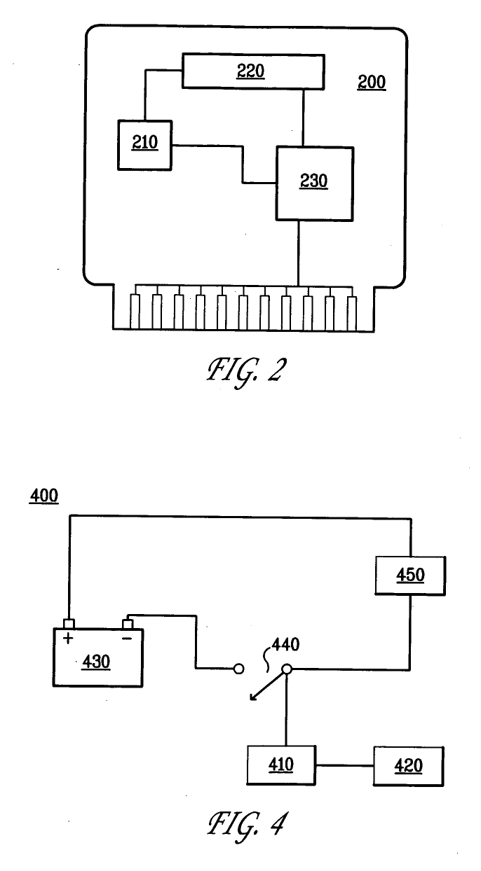

A peripheral control instruction is an instruction recognized by the peripheral device to undertake a particular action as it pertains to the operation of the peripheral device. For example, the peripheral control instruction may relate to power control of certain elements that are a part of the peripheral device. The peripheral control instruction may also relate to a command to ultimately be relayed to a conveyance via the peripheral device as a conveyance control signal. The peripheral control instruction recognized by the peripheral device and the conveyance control signal transmitted by the peripheral device are discussed in greater detail in FIGS. 2 and 3.

The conveyance control module installed on the mobile device 100 may comprise all necessary operating instructions in a single module. The conveyance control module may also be divided into various sub-modules on the mobile device 100. The sub-modules may interoperate by calling upon various routines residing in the various modules as is necessary. Certain routines may also reside in other modules stored elsewhere on the mobile device 100. For example, certain standard routines may be pre-installed on the mobile device 100 and re-authoring those routines as a part of the conveyance control module would represent unnecessary authoring and increased data storage requirements. The conveyance control module may, instead, call upon those routines already on the mobile device 100 as the operation of the conveyance control module and its related functions (e.g., displaying a conveyance control menu) requires.

Other routines may reside on other pieces of hardware coupled to the mobile device 100. For example, the aforementioned peripheral device (FIG. 2) may be coupled to the mobile device 100, the peripheral device being configured with certain software to allow for its operation and/or interaction with other components of or coupled to the mobile device 100.

Mobile device 100 further comprises an expansion slot 150 as illustrated in FIG. 1B. Expansion slot 150 may be a Secure Digital (SD) slot providing for the acceptance of SD cards (not shown). SD cards are small flash memory cards designed for the storage of data on, for example, digital cameras, MP3 Players and so forth. SD cards are, in some embodiments, approximately 32×24×2.1 mm and weigh approximately 2 grams.

Expansion slot 150 may be configured to read from and write to SD cards as well as MultiMedia Cards (MMCs). SD cards differ from MMCs in that SD cards provide a write-protect switch that prevents inadvertent overwriting. Some SD cards also provide security features for personal data, eBooks and so forth.

Expansion slot 150 may be further configured for Secure Digital Input/Output Support (SDIO). SDIO support allows expansion slot 150 to support more than memory cards such as SD cards and MMCs. With SDIO support, expansion slot 150 may interface with a peripheral device (FIG. 2) such as GPS receivers, 802.llb Wireless Ethernet Cards, SD Digital Cameras and so on.

Peripheral devices that interface with the mobile device 100 through expansion slot 150 may be configured with software that allows for interaction of the peripheral device with the actual mobile device 100 via the expansion slot 150 and its SDIO support (e.g., the communication of data or delivery/receipt of instructions). The mobile device 100 may further comprise software to aid in the installation of the peripheral device. This software may also be introduced to the mobile device through various installation routines as discussed previously in the present disclosure (e.g., synchronization).

A typical limitation to peripheral device insertion is physical compatibility (e.g., does the peripheral device fit within the SDIO supported expansion slot 150). This problem may be overcome through the sharing of design specifications between a peripheral manufacturer and the manufacturer of the mobile device 100 in that open-compatibility provides financial benefit to both parties (e.g., sale of the peripheral device for the peripheral manufacturer and increased phone value for the mobile device 100 manufacturer in that additional peripherals are available for use with the device).

Another limitation is software device compatibility. Most mobile devices, especially SmartPhones, are configured with a particular operating system (OS). In the case of the Treo600 as exemplified in FIG. 1A, the mobile device 100 is configured with Palm OS 5.2.x. As previously noted, a peripheral device may be configured with certain software to provide for interoperability of the peripheral device with the mobile device 100 via the SDIO supported expansion slot 150.

This interoperability is achieved, in part, through the sharing of Application Programming Interfaces (APIs). An API is a set of definitions of the ways one piece of computer software communicates with another. In this example, the APIs would relate to the communication of the software of the peripheral device with the operating system and other software components of the mobile device 100.

In some embodiments, as has been noted, requisite software may also be installed through the synchronization of the mobile device 100 with, for example, another computing device (e.g., a desktop computer). As previously noted, through synchronization, new software packages may be installed on mobile device 100, these software packages having been obtained, for example, through Internet downloads or physical media (e.g., an optical disk).

FIG. 2 illustrates an exemplary peripheral device 200 as may be utilized in a SDIO compatible mobile device. The exemplary peripheral device 200 provides for the receipt of peripheral control instructions from the mobile device 100 as well as the transmission of certain conveyance control signals from the peripheral device 200. The peripheral device 200 also provides for various system level communications between the peripheral device 200 and mobile device 100 as well as the transmission and receipt of certain authentication signals with a particular conveyance.

Peripheral device 200,comprises an authentication transponder 210. Through the use of authentication transponder 210, a conveyance may automatically detect and authenticate when the mobile device 100 equipped with peripheral device 200 (including authentication transponder 210) comes within a predefined zone surrounding a conveyance (e.g., 100 yards). Through the authentication of the mobile device 100 and peripheral device 200, the conveyance may then receive and process conveyance control signals generated by the mobile device 100 and peripheral device 200. The conveyance, upon authentication of the mobile device 100 via the authentication transponder 210 in peripheral device 200 may also allow for the transmission of certain status information of the conveyance to the peripheral device 200 for subsequent display at the mobile device 100.

For example, if the peripheral device 200 and authentication transponder 210 is detected inside the conveyance, the ignition of the conveyance may be activated (i.e., the engine may be started) either through a key turn, a button press inside the conveyance or an alternative means of starting the engine. In some embodiments of the present invention, mere presence of the transponder 210 within the predefined range may allow for ignition of the automobile through, for example, a conveyance control signal as may be generated by the peripheral device 200 in response to conveyance control instructions and peripheral control instructions or through a pre-setting as is discussed below.

Alternatively, If the transponder 210 is not detected inside the conveyance or the predefined range and an attempt is made to start the engine, then the conveyance will not respond (i.e., ignition will not occur).

Despite the absence of traditional mechanical contact between the conveyance and a key, access to the conveyance and exemplary ignition of the engine occurs utilizing radio communications. A second transponder in the conveyance (FIG. 3: 370) transmits a wake-up message on a low frequency of, for example, 10 kHz to 125 kHz to activate the first transponder (FIG. 2: 210) on the peripheral device 200. The peripheral device 200 configured with the first transponder 210 detects the low frequency signal, ‘wakes up’ and engages in an authentication exchange with the second transponder 370 in the conveyance. Once authentication has occurred, conveyance control signals transmitted by the peripheral device 200 may be received and processed by the conveyance whereby the activation of relevant conveyance functions may occur. Upon successful authentication, the entry device may return to a stand-by mode.

The transponder in the conveyance (370), in receiving the authentication signal from the first transponder (210), may measure the frequency strength of certain authentication signals. Based on the strength of these signals, the conveyance determines whether the first transponder (210) is located inside or outside the conveyance or within a predefined range allowing for operation of conveyance functions.

To avoid excessive drain on the mobile device 100 battery (not shown), a low-power, low-frequency wake-up receiver may be implemented in conjunction with the first transponder 210, such as the AS3931 manufactured by AustriaMicrosystems AG. The AS3931 is an ultra-low-power, three-channel LF ASK receiver designed to operate in various applications such as LF identification systems and LF tag receivers.

The AS3931 is able to detect low-frequency, ASK-modulated signals (e.g., those signals that may be generated by the second transponder 370) in the conveyance by looking for a digital wake-up pattern and generate a WAKE signal after successful pattern detection. Such a receiver is the only active circuit in the transponder 210 of the peripheral device 200 until otherwise activated through the WAKE signal thereby conserving battery power in the mobile device. In one embodiment, current consumption of the receiver is between 6.6 μA and 7.2 μA, supplied by the mobile device battery, which may be a rechargeable lithium ion battery.

Peripheral device 200 further comprises a wireless transceiver 220. Wireless transmitter may be a Wi-Fi (IEEE 802.11b) compliant LAN access device that enables communicative connectivity toga wireless network. An exemplary wireless transceiver 220 supports 40/64 and 128-bit WEP encryption. In order to preserve battery power in the mobile device, an embodiment of the exemplary wireless transceiver 220 consumes approximately 15 μA while idle and approximately 280 μA during the receipt or transmission of information. Power consumption of the wireless transceiver 220 may be further reduced such that the transceiver 220 only becomes active following a successful authentication operation between transponder 210 and transponder 370 or as a result of a WAKE signal as may be generated by a low-power, low-frequency wake-up receiver like that discussed above. The wireless transceiver 220 may further be operated as the result of a peripheral control instruction generated at the mobile device 100 as the result of certain user input.

An exemplary wireless transceiver 220 may operate in a frequency range of 2.4-2.5 GHz with a data rate of approximately 11 Mbps with dynamic range scaling to optimize range throughput. The exemplary wireless transmitter may further utilize Carrier Sense Multiple Access with Collision Avoidance protocols (CSMA/CA). Through the use of wireless transceiver 220, conveyance control instructions may be transmitted to an antenna (FIG. 3: 320) configured for receipt of those instructions at a conveyance.

In some embodiments, wireless transceiver 220 in conjunction with additional hardware and/or software known to one of skill in the art may be configured to piggy-back one signal on another signal. For example, the transponder signals exchanged during authentication may be carried be transmitted via the transceiver 220 or signals transmitted via the transceiver may be transmitted over frequencies utilized by the transponders 210 and 370. In yet another embodiment, the wireless transceiver 220 may not be necessary in that conveyance control signals are delivered over a cellular network as utilized by the likes of a cellular phone. Various data networks utilized in cellular services may also be utilized to communicate conveyance control signals between a conveyance and peripheral device 200 coupled to a mobile device 100.

As certain embodiments of the mobile device 100 of the present invention are full-duplex devices, one radio frequency may be used for the transmission of information while another is utilized for the receipt of information. One of those frequencies may be used to deliver conveyance control signals to the antenna 320 or other receiver device located at the conveyance. Utilizing any of a variety of cellular access technologies—CDMA2000, WCDMA or TD-SCDMA, for example—the transmission and receipt of these digital signals may occur. These signals are then exchanged between the cellular device and the conveyance.

Peripheral device 200 may also comprise memory 230. Memory 230 may be configured with certain information and/or logic as it pertains to conveyance conditions or instructions. For example, a user of an exemplary embodiment of the presently described system may desire to have certain pre-settings as they pertain to control of the conveyance. For example, a user may always wish to have the car pre-conditioned to a particular temperature with a particular CD playing in the stereo system upon entry into the conveyance. This information may be provided to memory 230 of the peripheral device 200 via various user inputs on the mobile device 100. Such ‘pre-settings’ may be retained in the memory 230 device.

Other types of pre-settings may be provided such as navigation information or sun-roof control. Different profiles may also be saved in the memory 230. For example, a ‘sunny day’ profile may provide for the retraction of the sub-roof while a ‘rainy day’ profile may provide for the sun-roof to be closed. ‘Hot weather’ or ‘cold weather’ profiles may also be provided whereby particular nuances of internal temperature are controlled. Profiles may also pertain to particular users of the automobile (e.g., a particular user who likes to have the automatic seat in a particular position) or a particular destination (e.g., as that destination may relate to going to work, going home, visiting a relative, etc.) Through the use of pre-settings as stored in memory 230, upon authentication of the mobile device 100 coupled to the peripheral device 200 via the authentication transponder 210, a conveyance control signal may immediately be transmitted to the conveyance without further input from the user.

Memory 230 may also be configured to retain other information such as a predefined distance at which certain signals may be transmitted and/or received from the mobile device 100/peripheral device 200 combination (e.g., 20 feet, etc.). Information pertaining to a predefined distance may be automatically configured by a manufacturer of the peripheral device 200 or, alternatively, may be provided by a user of the device through various user interfaces and commands provided via the mobile device (i.e., conveyance control instructions).

In some embodiments of the present invention, other hardware elements may be coupled to the peripheral device 200 such as certain keyless entry hardware offered by certain automobile manufacturers, for example, hardware related to Keyless-Go™ functionality as offered in the Mercedes Benz S-Class. Various hardware (and related software) may be controlled via the mobile device 100 and related user interfaces as may be provided by the hardware manufacturer or otherwise installed on the mobile device 100 through, for example, a synchronization operation.

Peripheral device 200 may be configured to offer certain ‘valet key’ type functionality. In the context of a physical lock-and-key environment with an automobile, the valet key allows a third-party to open the doors of the automobile and to start the engine but not to have access to, for example, the trunk or the glove box. Peripheral device 200 may be manufactured as to offer full owner functionality and/or limited valet functionality such that a mobile device 100 owner may replace an ‘owner peripheral device’ with a ‘valet peripheral device’ upon allowing a third-party temporary use of their automobile (e.g., for the purposes of valet parking at a hotel). As such, the third-party would have limited control over certain automobile functionality.

In other embodiments, the conveyance control module installed on the mobile device 100 may have certain security functionality as to ‘lock out’ certain conveyance controls that should not be extended to a third-party. Through these security controls, the third-party may be able to lock and unlock the doors of an automobile but not to control certain GPS, environmental, stereo or other controls that are beyond the need of the third-party. Certain functionality related to the mobile device may also be locked out. For example, the third-party may have the ability to control limited automobile functionality but not to make phone calls in the case of the mobile device being a cellular telephone. Similarly, if the present invention is embodied in an alternative piece of hardware (e.g., a portable music device or PDA), those functions, too, may be locked out and beyond the control of the third-party. Various profiles may be assigned depending on the use rights of a particular user (e.g., owner versus child versus valet versus spouse).

FIG. 3 illustrates an exemplary embodiment of a communication and control system 300 as utilized in a conveyance in an embodiment of the present invention. Control system 300 comprises a body controller computing device 310, antenna 320, authentication transponder 370 and various conveyance operation control devices such as lock actuators 330, ignition system 340, environmental control system 350 and stereo system 360, although additional devices may be utilized within the scope of the present invention to the extent they are capable of being controlled by a body controller 310 or a related computing device capable of receiving operating instruction in a conveyance.

Body Controller 310 is a computing device and/or computing network located within the conveyance. The body controller 310 uses certain vehicle and/or environmental factors to control various conveyance functionalities via an instrument cluster operation system to which all instruments of a conveyance that are subject to control are connected. A body controller 310 is commercially referenced by different names within the automotive industry. For example, in a Mercedes Benz S-Class, the body controller 310 is referred to as the Control Area Network (CAN) system.

Body controller 310, in some embodiments; controls the interior lights of the automobile, the emissions of certain warning alarms.(e.g., headlights are on with the ignition off or keys are left in the ignition with a car door open) and a number of other functions as may be assigned by the manufacturer of the particular conveyance and body controller 310. Body controller 310 is, at its very essence, a computing device capable of being configured with necessary hardware and/or software to undertake any necessary processing function or operation execution through a conveyance control command.

Body controller 310 is coupled to antenna 320 and an antenna module (not shown). Antenna 320 receives various conveyance control signals via, for example, a wireless LAN, cellular network or other RF transmission. Antenna 320 receives the conveyance control signals and, via software implemented through the antenna module, converts those conveyance control signal into instructions executable or otherwise comprehensible to the body controller 310 (e.g., a conveyance control command). That is, the antenna module takes the semantics of the conveyance control signals and converts them into syntax understood by the body controller computing device 310—the conveyance control command.

Body controller 310, via antenna 320, may receive a conveyance control signal reflecting an instruction to unlock or lock conveyance door locks, roll up or roll down windows, to allow for ignition of the engine and so, forth. When antenna 320 receives a conveyance control signal, the antenna 320 in conjunction with the antenna module will translate that instruction into a conveyance control command recognizable by the body controller 310. Body controller 310 will then provide for electrical power to a conveyance operation control device and any necessary data transmission (instruction) to allow for the occurrence of a certain action related to the conveyance. Examples of conveyance operation control devices include power door locks, power windows, an air conditioning system, an ignition system, seat positioning, steering wheel positioning, stereo system control, GPS navigation control and so forth.

For example, antenna 320 may receive a conveyance control signal to open the door locks of a conveyance. The antenna 320 and antenna module will recognize that signal and translate it into a conveyance control command recognized by body controller 310, which will provide power to the appropriate conveyance operation control device controlling the door locks from a battery (not shown). In this example, the conveyance operation control device is the power-door-lock actuator 330.

For example, power-door-lock actuator 330, in an embodiment of conveyance, is positioned below a door latch. An extension device (e.g., an actuator rod) connects the actuator to the door latch. When provided with power, the actuator 330 will cause the latch (via the extension device) to be positioned in such a way as to allow for the opening and closing of the door (i.e., the door is unlocked). Alternatively, the actuator 330 may reposition the latch such that the door cannot be opened (i.e., the door is locked).

To unlock the door, the body controller 310 provides actuator 330 with power for a timed interval as to allow for the unlock positioning of the latch. Once that timed interval expires, the power to the actuator 330, as provided for by body controller 310, is discontinued and the actuator 330 returns to its initial, un-powered state whereby the door latch causes the locking of the door. The actual operation of the actuator 330 is well known in the art and, in some embodiments, concerns the use of a small electric motor and a series of spur gears including a gear that drives a rack-and-pinion gear set that is connected to the aforementioned connection device (e.g., the actuator rod). The gear set converts the rotational motion of the gears into the linear motion necessary to move the door lock.

A similar interaction applies to the operation of power windows. For example, body controller 310, via antenna 320 and antenna module, will receive a conveyance control signal indicating the need to roll-up or roll-down windows in a conveyance. Power will be provided to power window actuator 340 that comprises an electric motor attached to a series of spur gears that provide the requisite torque to lift or lower a window. Similar interactions pertain to the control of, for example, an air conditioning system in the automobile wherein the requisite fan and ventilation system 350 including the air compressor may be provided with power from body controller 310 in response to signals received by antenna 320 and translated into conveyance control commands by the antenna module.

Ignition of the conveyance may also be controlled through body controller 310 and antenna 320 that receives a conveyance control signal. Upon receipt of the signal, the antenna 320 and antenna module translate the signal into a command recognizable by the body controller 310. Body controller 310, in response to the translated command, allows for the provisioning of power from the battery to provide the requisite voltage to an ignition system 350 comprising a series of spark plugs wherein an arc generated across a gap in the series of spark plugs creates a spark strong enough to ignite an air/fuel mixture in a combustion chamber. The operation of various ignition systems 350 are well known in the art.

Conveyance control signals and resulting conveyance control commands may also be utilized to control the operation of a car stereo 360 as an example of another conveyance control device. Radios, including car stereos, operate on the basis of amplitude modulation (AM) and frequency modulation (FM).

If the amplitude or strength of a radio signal is changed, the information that is transmitted on a particular signal can be varied. By ‘tuning’ a receiver as found in a car stereo, the particular amplitude signal and the information it carries (e.g., a particular radio station) to be received can be varied. It is in this way that a user of a stereo ‘changes’ the station, that is, the receiver is configured to receive a particular modulated signal and the radio information that is a part of that signal. A similar approach applies to frequency modulation wherein the frequency of a carrier wave is varied. By tuning the receiver to a particular frequency, particular channels of information can be received.

A conveyance control signal may be received by the antenna 320 and through body controller 310 and a corresponding conveyance control command may provide for the delivery of power to the stereo 360 and further to provide for a change in the frequency or amplitude signal to be received by the radio receiver in the conveyance.

In one embodiment, previously described transponder 370 interacts with the transponder (210) in the peripheral device 200 utilizing digital spread spectrum (DSS) technology. DSS may be implemented through the use of frequency hopping. Through frequency hopping, a spread spectrum system rapidly switches from one frequency to the next wherein the subsequent frequency selection is random. Through the use of a clock at a pseudo-random number generator at each transponder, the first and second transponders (210/370) remain synchronized allowing for previously referenced authentication operations. Once the second transponder 370 located in the conveyance authenticates the first transponder 210 at the mobile device 100, the transponder 370 may allow for the antenna 320 to receive conveyance control signals from the mobile device 100 whereby various conveyance functionalities may be controlled. Transponders may further or alternatively utilize a challenge-response authentication mechanism (CRAM) to provide authentication and remote control of various conveyance functionalities.

Through the use of the present system, other conveyance settings may be remotely controlled, such as pre-setting GPS navigation whereby the requisite software is configured in the conveyance and/or the mobile device or its associated peripheral device to pre-set a destination in a GPS-configured conveyance. Such settings are remotely transmitted utilizing the mobile device configured with the conveyance control module.

Certain software may be further configured within the body controller 310 or some other element of the conveyance where the status of the conveyance is observed (e.g., interior temperature, tire pressure, CDs in a CD-player and so forth) and wirelessly communicated to the mobile device via antenna 320. That information may be subsequently received at the mobile device 100 via, for example, the wireless transceiver 220 of the peripheral device 200 and displayed utilizing the interface provided by the conveyance control module. Such information may include that information normally utilized by an onboard diagnostic computing device (not shown) that may be communicatively coupled to the body controller 310 or otherwise configured to provide that information to the antenna 320 for subsequent communication to the mobile device.

The particular operation of any conveyance operation device is generally known in the art with regard to the particular mechanical manipulation of those devices via, for example, body controller 310 or other operational mechanics or data exchanges within a conveyance.

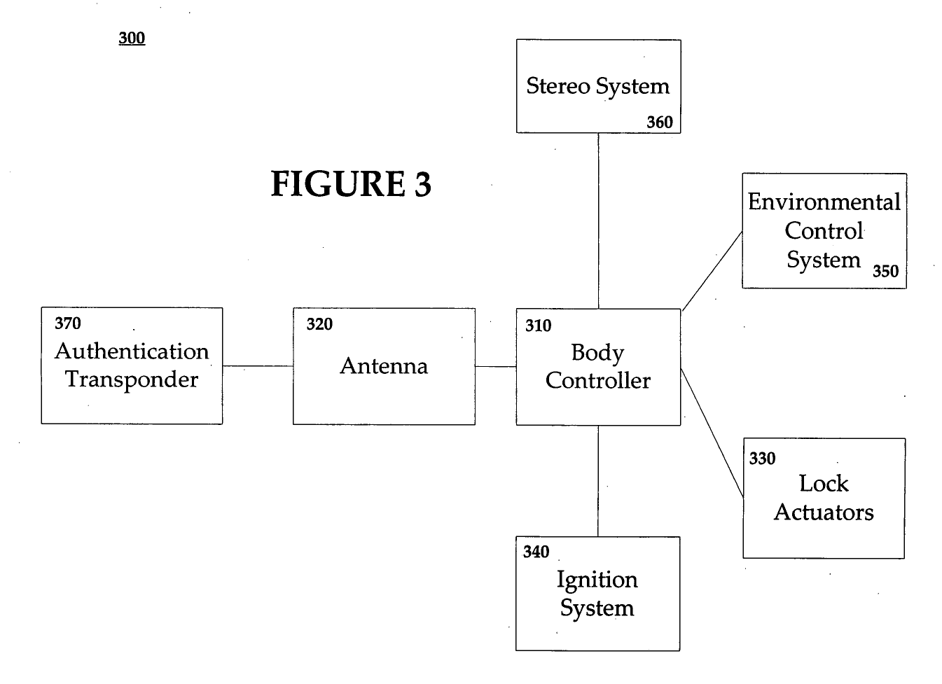

FIG. 4 illustrates an exemplary power system 400 as may be governed by a body controller 410 like that referenced in FIG. 3 (310). In one embodiment, the power system 400 comprises body controller 410, which is coupled to battery 430 and antenna 420 (like that described in FIG. 3: 320). As the body controller 410 receives commands as translated by the antenna 420 and antenna module (not shown), the body controller 410 will control various switches 440 in the system 400. For example, by opening or closing switch 440, the body controller 410 may control the presence or lack of power as provided by battery 430 to motor 450. Motor 450 may aid in the operation of power windows or power door locks. Instead of motor 450, this particular element may be any other aspect of an automobile requiring a power source, for example, an ignition system, an air conditioning system or a stereo system.

In the present embodiment, it should be noted that a single circuit is illustrated. This is not to suggest that the power system of a conveyance be limited to such a single circuit. In fact, in many conveyances, a complex wiring system comprising additional relays and multiplexers may be utilized. Further, body controller 410 may also provide data coupling whereby certain information concerning control of certain conveyance functions (e.g., configured a radio receiver for a particular modulated signal in the stereo system or control of air temperate in the air conditioning system) outside the realm of mere power are concerned.

FIGS. 5A-5C illustrate various exemplary views of a user interface as may be generated by a conveyance control module in a mobile device.

FIG. 5A illustrates a mobile device 500 like that described in FIG. 1A. Mobile device 500 comprises a peripheral device 510 like that described in FIG. 2 in addition to a display 520 and five-way-navigation control 530. On the display 520 is an exemplary interface menu 540 (e.g., a conveyance control menu) reflecting various remote access control features as would be generated by a conveyance control module. Each item in the interface menu 540 is associated with a particular command control of the conveyance. For example, <temperature> is associated with control of certain environment conditions in the associated conveyance; <convertible top> is associated with the control of a convertible top of the conveyance; <windows> are associated with the opening and closing of windows; <audio> is associated with control of a stereo system in the conveyance; <navigation> is associated with control of, for example, a GPS system in the conveyance; and <engine> is associated with starting the engine of the conveyance. The list of control functions in FIG. 5A is not meant to be exclusive but, instead, exemplary.

FIG. 5B illustrates an exemplary interface menu following the selection of a particular command function. For example, command function 550 for <temperature> has been selected, which has resulted in a new drop down menu 560 of related commands. The drop down menu 560 comprises commands for <A/C> for air conditioning control; <heater> for heater control and <defrost> for defrosting of front or rear windows. The selection of any one of these commands may result in the presentation of additional drop-down menus or the generation of commands to the conveyance control module to generate the necessary peripheral control instructions to be subsequently delivered to the conveyance as conveyance control signals as they relate to that particular function.

FIG. 5C illustrates an exemplary vehicle information interface 570 as may be generated by the conveyance control module in response to the receipt of conveyance information as may be generated by a diagnostic computer on board the conveyance. In the present example, information pertaining to fuel level, tire pressure, lock status of the door, interior temperature and windows status is reflected. The list of status information is not meant to be exclusive and may vary dependent upon the information delivered by the appropriate sensors and computing device in the conveyance and communicatively coupled to the antenna and related antenna module so that it may convert and convey the diagnostic information to the mobile device.

It should be noted that in some embodiments of the present invention, the peripheral device of FIG. 2 or certain elements coupled to the peripheral device of FIG. 2 may be configured as an integrated portion of the mobile device 100. In such an embodiment, it would not be necessary for a peripheral device to be coupled to the mobile device as the transponder authentication functionality, for example, is built directly into the device. Further, a wireless transmitter, as described in FIG. 2, may not be necessary if the mobile device is configured to transmit command information over a cellular network or via GPRS.

In yet another embodiment of the present invention, the peripheral device 200 may be configured as to be coupled to other hardware devices. For example, a PDA may be configured with SDIO or similar functionality as to allow for the exchange of information and instructions between the PDA and the peripheral device 200 in a manner similar to that of the mobile device 100 and peripheral device 200.

In still other embodiments, the peripheral device 200 may be configured in such a way as to allow for introduction of the device into, for example, a portable music device. Most portable music devices comprise a data port for the downloading of music or video from a computing device. For example, an embodiment of the iPod™ from Apple Computer, Inc. comprises a USB connector allowing for USB 1.1 and 2.0 connectivity. Subject to the exchange of appropriate APIs, the peripheral device 200 could be introduced into the iPod™, an embodiment of which comprises a 30 GB to 60 GB hard drive. Provided appropriate firmware upgrades have been made to the music device and/or peripheral device 200, the radial menu controls on the iPod™ could be utilized to control various operations in the peripheral device 200, which would then generate the appropriate conveyance control signals for a conveyance.

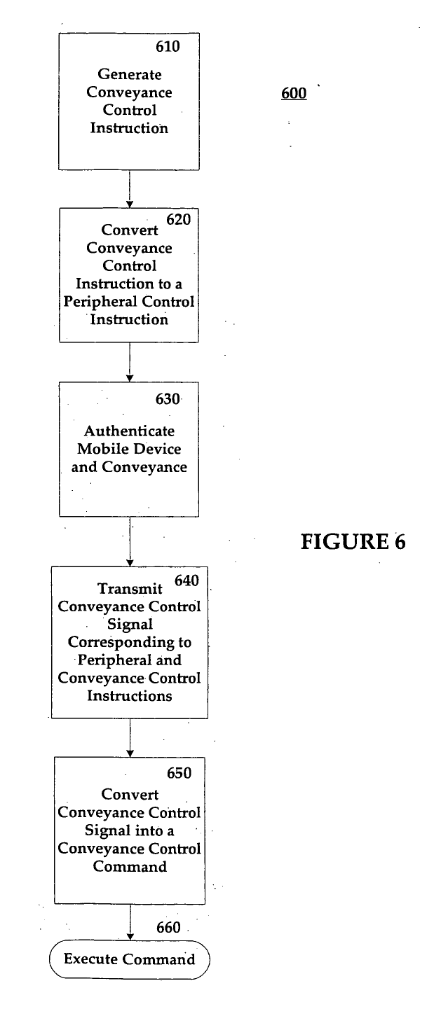

FIG. 6 illustrates an exemplary method 600 for remotely controlling conveyance functions utilizing a mobile device configured with a conveyance control module.

In step 610, a conveyance control instruction is generated. This instruction may correspond to, for example, the user‘s intent to ignite the engine of a conveyance. Conveyance control instruction is entered through, for example, a keypad on the mobile device. In step 620, that conveyance control instruction is converted into a peripheral control instruction by the conveyance control module, which may operate in conjunction with various other software and/or hardware provided by the mobile device and/or a peripheral device. That is, the particular syntax of the command is recognized by the mobile device and input through the aforementioned keypad is converted into a command syntax that may be processed by a wireless transceiver as may be found in a peripheral device like that described in FIG. 2. Notwithstanding the syntax conversion of the instruction, the semantic intent remains the same (e.g., ignite the engine).

In step 630, an authentication process takes place between the mobile device and the conveyance. This authentication process involves a transponder at the mobile device (like that described in FIG. 2) and a similar transponder at the conveyance (as described in FIG. 3). Absent the successful completion of the authentication process in step 630, any conveyance control signal transmitted by the wireless transceiver will either not be received by an antenna at the conveyance or, alternatively, may be disregarded.

In step 640, a conveyance control signal corresponding to the peripheral control instruction, which in turn corresponds to the conveyance control instruction, is generated and transmitted to an antenna at the conveyance.

In step 650, this conveyance control signal is converted into a conveyance control command. The conveyance control command is an instruction recognized by the applicable machinery or computing devices on board a conveyance (e.g., a body controller). In step 660, the conveyance control command is executed. In this example, the ignition of the automobile is activated through the body controller allowing for the passage of requisite power from the battery to the spark plugs of the ignition system.

Notwithstanding the providing of detailed descriptions of exemplary embodiments, it is to be understood that the present invention may be embodied in various forms.

For example, the present invention may be embodied in a remote entry system for a traditional home or office door wherein a deadbolt or other locking mechanism is remotely operated via a control signal transmitted from a mobile device via, for example, a peripheral device coupled to the mobile device. Such operation would be similar to a conveyance control signal with the exception that the signal in the present example corresponds to or is converted into a signal or command understood by certain lock mechanics and/or related computing equipment controlling the operation of the deadbolt or locking mechanism. Related software modules may be found at the mobile device to control particular operations of the locking mechanism and/or an intermediate peripheral device including software related to the generation of a user interface providing various control options.

The present invention may be further utilized to control the operation of any other personal space (e.g., home or office) utility and/or appliance that is capable of being communicatively coupled to mechanics and/or computing equipment capable of receiving a wireless control signal and effectuating a response or intermediate action in response to that control signal; For example, the present invention may be further utilized to remotely control home alarm functions (e.g., remotely providing an alarm code to disarm an alarm prior to home entry), home environment conditions (e.g., controlling heat and air conditioning) as well as home entertainment equipment (e.g., changing the channel or power status of a stereo or television).

Therefore, specific details disclosed herein are not to be interpreted as limiting, but rather as a basis for the claims and as a representative basis for teaching one skilled in the art to employ the present invention in virtually any appropriately detailed system, structure, method, process, or manner.

What is claimed is:

1. A method for controlling an operation at a conveyance, comprising:
entering a conveyance control instruction;
converting the conveyance control instruction into a command executable by a wireless transceiver;
transmitting a wireless signal to the conveyance, the wireless signal corresponding to the conveyance control instruction; and
executing an operation at the conveyance, the operation corresponding to the conveyance control instruction.

2. The method of claim 1, further comprising authenticating a device transmitting the wireless signal to the conveyance prior to executing the operation at the conveyance.

3. The method of claim 2, wherein the operation at the conveyance executes only if the device transmitting the wireless signal is verified to be within a predetermined distance of the conveyance.

4. The method of claim 1, wherein the conveyance control instruction is selected from a plurality of conveyance control instructions provided in a conveyance control menu.

5. The method of claim 4, wherein the conveyance control menu is generated by a conveyance control module.

6. The method of claim 1, wherein the wireless signal is transmitted over a cellular network.

7. The method of claim 1, wherein the wireless signal is transmitted over a Wi-Fi compatible network.

8. The method of claim 1, wherein the wireless signal corresponding to the conveyance control instruction also comprises preset information corresponding to an operation at the conveyance.

9. A system for remote control of conveyance operations, comprising:
a mobile device, comprising:
means for generating conveyance control instructions;
a conveyance control module, the conveyance control module configured to accept conveyance control instructions received from the means for generating conveyance control instructions; and
an expansion slot configured for secure digital input/output support;
a peripheral device configured for insertion into the expansion slot, the peripheral device comprising:
a peripheral transponder configured to exchange authentication data with a second transponder; and
a wireless transceiver configured to transmit a conveyance control signal;
a conveyance, comprising:
a conveyance transponder configured to exchange authentication data with the peripheral transponder;
an antenna module configured to convert the conveyance control signal into a conveyance control command;
at least one conveyance operation control device, the conveyance control device configured to control the operations of at least one conveyance operation in response to the conveyance control command.

10. The system of claim 9, wherein the conveyance control module is further configured to generate a conveyance control menu for display on the mobile device.

11. The system of claim 9, wherein the conveyance control module is further configured to convert the conveyance control instruction into a peripheral control instruction.

12. The system of claim 9, wherein the exchange of authentication data comprises frequency hopping.

13. The system of claim 9, wherein the exchange of authentication data comprises challenge-response authentication.

14. The system of claim 9, wherein the conveyance transponder is further configured to control the receipt of the conveyance control signal by the conveyance.

15. The system of claim 9, wherein the peripheral device further comprises a memory configured to store preset information.

16. The system of claim 15, wherein the preset information comprises a profile.

17. The system of claim 16, wherein the profile corresponds to conveyance control commands that are automatically executed at the conveyance when the mobile device is within a predefined range of the conveyance.

18. The system of claim 9, wherein the mobile device is a cellular telephone.

19. The system of claim 9, wherein the mobile device is a PDA.

20. The system of claim 9, wherein the mobile device is a portable music device.

21. A machine readable medium having embodied thereon a program being executable by a machine to perform a method comprising:
generating a conveyance command menu listing a plurality of conveyance control instructions;
accepting at least one of the plurality of conveyance control instructions; and
converting the conveyance control instruction into a command language executable by a wireless transceiver.

22. The machine readable medium of claim 19, the method further comprising:
converting conveyance status information received from the conveyance by the wireless transceiver into a command language executable by a mobile device; and
causing the mobile device to render the status information in a graphic user interface at the mobile device.

23. A system for remote control of a personal space appliance, comprising:
a mobile device, comprising:
means for generating appliance control instructions;
a control module, the control module configured to accept appliance control instructions received from the means for generating appliance control instructions; and
an expansion slot configured for secure digital input/output support;
a peripheral device configured for insertion into the expansion slot, the peripheral device comprising a wireless transceiver configured to transmit an appliance control signal;
a personal space appliance configured to receive the appliance control signal and perform at least one function in response to the appliance control signal, the appliance control signal corresponding to the appliance control instruction.
